(19) United States
(12) Patent Application Publication
(10) Pub. No.: US 2022/0051133 A1
(43) Pub. Date: Feb. 17, 2022

(54) DECENTRALIZED MULTI-TASK LEARNING

(71) Applicant: NEC Laboratories Europe GmbH, Heidelberg (DE)

(72) Inventors: Tobias Jacobs, Mannheim (DE); Anil Goyal, Rohtak (IN)

(21) Appl. No.: 17/078,210

(22) Filed: Oct. 23, 2020

Related U.S. Application Data
(60) Provisional application No. 63/064,428, filed on Aug. 12, 2020.

(51) Int. Cl. G06N 20/00; G06K 9/62

(52) U.S. Cl. CPC G06N 20/00; G06K 9/624; G06K 9/623; G06K 9/6256

(57) ABSTRACT

A method for decentralized multi-task learning includes publishing metadata associated with a first task. A plurality of parameter vectors associated with a set of similar tasks to the first task is obtained and the set of similar tasks is associated with a plurality of other participants. A parameter vector associated with a machine learning dataset for the first task is trained based on a loss function associated with the first task and the plurality of parameter vectors associated with the set of similar tasks. The parameter vector associated with the machine learning dataset for the first task is published.

### CROSS-REFERENCE TO PRIOR APPLICATION

Priority is claimed to U.S. Provisional Application No. 63/064,428 filed on Aug. 12, 2020, the entire contents of which is hereby incorporated by reference herein.

### FIELD

The present invention relates to a method, system and computer-readable medium for decentralized machine learning.

### BACKGROUND

In distributed multi-task learning, a multitude of participants learn their individual prediction models, each maintaining their own training data. Whenever the quantity and/or quality of training data for the individual tasks is insufficient for learning high-quality prediction models, multi-task learning techniques come into play, where knowledge is shared between tasks to improve the quality of the models. A large number of techniques for knowledge sharing have been discussed (see He, Xiao, et al., “Efficient and Scalable Multi-Task Regression on Massive Number of Tasks,” Proceedings of the AAAI Conference on Artificial Intelligence, Vol. 33 (2019); and Liu, Kunpeng, et al., “Privacy-Preserving Multi-task Learning,” 2018 IEEE International Conference on Data Mining (ICDM), IEEE (2018); each of which is hereby incorporated by reference herein).

The centralized approach is to run the multi-task training procedure on a single computer, which has access to all training data (see He, Xiao, et al.). In practice, using this approach for the case of multiple participants has the limitations that: (a) the communication overhead of transferring all training data is high, especially when the number of tasks is massive, when and the tasks and set of participants change over time; (b) transferring the training samples is often not permissible due to data privacy reasons (e.g., legislation on personal data protection, protection of sensitive business or governmental data); and (c) all participants need to agree on a central trusted entity and a common communication protocol, making the adoption barrier high.

To overcome limitations (a) and (b), Liu, Kunpeng, et al. propose an approach for privacy-preserving multi-task learning, where aggregates of the training data are computed and transferred to a central server in encrypted form. Based on these aggregates, the server then computes information based on which each participant can improve its local model. This approach does not address limitation (c). Similar observations hold for a recent approach using asynchronous updates for privacy-preserving distributed multi-task learning (see Xie, Liyang, et al., “Privacy-preserving distributed multi-task learning with asynchronous updates,” Proceedings of the 23rd ACM SIGKDD International Conference on Knowledge Discovery and Data Mining (2017), which is hereby incorporated by reference herein.

Finally, a decentralized approach without a central server has been proposed in Zhang, Chi, et al, “Distributed multi-task classification: a decentralized online learning approach,” Machine Learning 107.4 (2018):, pp. 727-747 (2018), which is hereby incorporated by reference herein. This approach addresses providing for a common server, but does not provide a suitable solution for addressing limitation (c) because it comes at the cost of introducing and using a complex communication protocol that runs in several phases. Thus, in this case, the limitation (c) of having to agree on a common trusted entity and common communication protocol is supplemented with the limitation of having to agree on a particularly complex communication protocol, raising the adoption barrier even higher.

### SUMMARY

In an embodiment, the present invention provides a method for decentralized multi-task learning. The method includes the steps of: publishing metadata associated with a first task; obtaining a plurality of parameter vectors associated with a set of similar tasks to the first task, wherein the set of similar tasks is associated with a plurality of other participants; training a parameter vector associated with a machine learning dataset for the first task based on a loss function associated with the first task and the plurality of parameter vectors associated with the set of similar tasks; and publishing the parameter vector associated with the machine learning dataset for the first task.

### BRIEF DESCRIPTION OF THE DRAWING

Embodiments of the present invention will be described in even greater detail below based on the exemplary figure. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawing which illustrates the following:

FIG. 1a shows a communication pattern for decentralized multi-task learning including publishing and obtaining metadata and parameter vectors according to an embodiment of the present invention;

FIG. 1b shows a method and system architecture for the communication pattern of

FIG. 1a according to an embodiment of the present invention;

FIG. 2 shows another method and system architecture for decentralized multi-task learning according to an embodiment of the present invention; and

FIG. 3 shows a process for decentralized multi-task learning according to an embodiment of the present invention.

### DETAILED DESCRIPTION

Embodiments of the present invention provide a method, system and computer-readable medium for decentralized distributed machine-learning, where each participant learns a prediction task from its local training data, while exploiting task similarities between the participants to improve the quality of all prediction models. Embodiments of the present invention provide a reduced or minimal adoption barrier due to: (a) low communication overhead; and (b) robustness against non-cooperating participants. Furthermore, embodiments of the present invention may extend to a dynamic situation where, over time, (i) participants and tasks are added and removed, and (ii) the tasks and training data of participants changes. Thus, embodiments of the present invention may improve distributed learning by using more efficient, yet secure communication, in a manner which is robust to non-cooperating participants and provides flexibility for dynamic implementations.

Among other advantages, embodiments of the present invention provide a low adoption barrier due to simplicity of communication, avoid the need to publish individual data samples, provide scalability to a massive number of tasks, and provide robustness to the approach. For instance and as will be explained in further detail below, embodiments of the present invention preserves privacy (e.g., participants such as users might not be required to reveal their training data and metadata/parameters may be published in anonymized form), may be asynchronous (e.g., participants may run the algorithm described below at any time, independent of other participants), may be Pareto-optimal (e.g., participants are incentivized to run the algorithm described below because it improves the generalization capacity of their model with each run), achieves global optimality under certain conditions, provides for stability, robustness, computational efficiency, stability, and low entry barrier, and may be used in the continual learning setting (e.g., where the objective is to efficiently learn new tasks using past knowledge without forgetting on new tasks).

In an embodiment, the present invention provides a method for decentralized multi-task learning. The method includes the steps of: publishing metadata associated with a first task; obtaining a plurality of parameter vectors associated with a set of similar tasks to the first task, wherein the set of similar tasks is associated with a plurality of other participants; training a parameter vector associated with a machine learning dataset for the first task based on a loss function associated with the first task and the plurality of parameter vectors associated with the set of similar tasks; and publishing the parameter vector associated with the machine learning dataset for the first task.

In an embodiment, the method further comprises: obtaining the set of similar tasks to the first task, wherein the set of similar tasks are performed by the plurality of other participants.

In an embodiment, the metadata comprises a plurality of parameters associated with a single task model and one or more other parameters associated with properties of the first participant.

In an embodiment, publishing the metadata comprises providing the metadata associated with the first task to a registry, obtaining the plurality of parameter vectors comprises obtaining, from the registry, the plurality of parameter vectors based on providing the metadata to the registry, and publishing the parameter vector comprises providing the parameter vector to the registry.

In an embodiment, the method is performed by a first participant device, the plurality of other participants comprises a second participant device, and the plurality of parameter vectors comprises a set of parameter vectors associated with the second participant.

In an embodiment, publishing the metadata comprises providing the metadata associated with the first task to the second participant device, obtaining the plurality of parameter vectors comprises obtaining, from the second participant device, the plurality of parameter vectors based on providing the metadata to the second participant device, and publishing the parameter vector comprises providing the parameter vector to the second participant device.

In an embodiment, training the parameter vector associated with the machine learning dataset is based on minimizing the parameter vector using a first function comprising the loss function and a distance metric associated with the plurality of parameter vectors.

In an embodiment, the distance metric is a norm function that determines similarities between the parameter vector and the plurality of parameter vectors associated with the set of similar tasks.

In an embodiment, the plurality of other participants comprises a second participant associated with a second participant device, the second participant device uses the parameter vector associated with the first task to train a second parameter vector associated with a second machine learning dataset for a second task, and the second participant device publishes second metadata associated with the second task and the second parameter vector.

In another embodiment, the present invention provides a system for decentralized multi-task learning. The system comprises a first participant device comprising one or more first processors which, alone or in combination, are configured to facilitate: publishing metadata associated with a first task; obtaining a plurality of parameter vectors associated with a set of similar tasks to the first task, wherein the set of similar tasks is associated with a plurality of other participants; training a parameter vector associated with a machine learning dataset for the first task based on a loss function associated with the first task and the plurality of parameter vectors associated with the set of similar tasks; and publishing the parameter vector associated with the machine learning dataset for the first task.

In an embodiment, the one or more first processors are configured to further facilitate: obtaining the set of similar tasks to the first task, wherein the set of similar tasks are performed by the plurality of other participants.

In an embodiment, the system further comprises a registry comprising one or more second processors which, alone or in combination, are configured to facilitate: receiving, from the first participant device, the metadata associated with the first task; providing, to the first participant device, the plurality of parameter vectors associated with the set of similar tasks to the first task; and receiving, from the first participant device, the parameter vector associated with the machine learning dataset for the first task.

In an embodiment, the system further comprises: a second participant device comprising one or more second processors which, alone or in combination, are configured to facilitate: publishing second metadata associated with a second task; obtaining a plurality of second parameter vectors associated with a set of second similar tasks to the second task, wherein the plurality of second parameter vectors comprises the parameter vector associated with the first task, and wherein the set of second similar tasks comprises the first task; training a second parameter vector associated with a second machine learning dataset for the second task based on a second loss function associated with the second task and the plurality of second parameter vectors; and publishing the second parameter vector associated with the second machine learning dataset for the second task.

In an embodiment, the one or more first processors, alone or in combination, are configured to further facilitate: updating the parameter vector associated with the machine learning dataset at a first time. The one or more second processors, alone or in combination, are configured to further facilitate: updating the second parameter vector associated with the second machine learning dataset at a second time that is different from and asynchronous with the first time.

In a further embodiment, a tangible, non-transitory computer-readable medium having instructions thereon which, upon being executed by one or more processors, alone or in combination, provide for execution of a method according to any embodiment of the present invention.

According to embodiments of the present invention, each participant (e.g., each user or user device) may only publish the following data: (i) some metadata based on which task similarity can be estimated, and (ii) the parameters of the most recent model. For example, a participant may provide the metadata and/or the parameters to a registry. Additionally, and/or alternatively, one or more forwarding mechanisms may be used to provide the data between the participants without the use of a central registry. In some instances, the metadata may be and/or include descriptive data about the task, based on which the similarity of other tasks can be measured. In some variations, a model, such as the most recent model, may be a function such as f(x, theta), where x is the input and theta consists of the parameters of the model. During training, a value of theta may be chosen, which makes the f(x, theta) an accurate model with respect to the training data.

Participants may choose to update their models asynchronously at any time and in any frequency, and convergence to an optimum of the central multi-task learning problem provided in He, Xiao, et al. is guaranteed under mild assumptions. In some instances, the participants may be fixed (e.g., no participants may be added or removed after initiation. In other instances, there may be a registration of participants (e.g., participants may be added or removed). In yet other instances, it may be open without registration (e.g., anyone who would want to be a participant may be a participant).

Publication of data (i) and (ii) is in line with two recent trends in public services: the “open data” paradigm, encouraging public organizations to publish their data and metadata (see <<https://ec.europa.eu/digital-single-market/en/european-legislation-reuse-public-sector-information>>), and the “explainable AI” trend, encouraging stakeholders to make decisions based on artificial intelligence transparent (see <<https://ec.europa.eu/jrc/en/publication/robustness-and-explainability-artificial-intelligence>>), which includes publication of the model parameters even if the individual data samples cannot be published. In cases where publication is not admissible, anonymization can be applied, or a central trusted server can be utilized.

Embodiments of the present invention consider the situation where a number of participants want to train prediction models for individual tasks T₁, . . . , Tₙ. Each task Tᵢ is associated with a data set Xᵢ, Yᵢ of labeled training data over a common set of features, and, when using single-task machine learning, the prediction models are trained by determining the parameter vector θᵢ to minimize a loss function L(Xᵢ, Yᵢ, θᵢ), where L expresses the prediction error and, potentially, regularization terms. In some instances, one or more participants may acquire a data set Xᵢ, Yᵢ for task Tᵢprior to performing Algorithm A below. In other instances, one or more participants may acquire a data set Xᵢ, Yᵢ, for task Tᵢ subsequent to performing Algorithm A below. For example, initially, a participant may perform Algorithm A without having its own data set for a task. Then, the data set may be changed or enhanced between two or more consecutive executions of Algorithm A.

The idea of multi-task learning is to improve the models by exploiting similarities between the tasks. While a considerable range of techniques for multi-task learning have been described in literature, an embodiment of the present invention utilizes a technique which is based on the following paradigm: similar tasks should have similar models. An undirected similarity graph G=({1 . . . n},E) is assumed, with the nodes (n) associated with the tasks, where E contains edges between similar tasks. Estimating task similarities according to embodiments of the present invention will be discussed in more detail below. In some variations, the similarity graph may be calculated based on the task metadata. For example, tasks with similar metadata may have a similarity link between them. The multi-task objective function introduces additional regularization terms, which encourage similar tasks to have similar models as follows:

Σ_{i=1,n}L(Xᵢ, Yᵢ, θᵢ)+Σ_{(i,j)∉E}d(θᵢ, θⱼ) Equation (1)

where d(θᵢ, θⱼ) is a distance metric to compare weight vectors of prediction models i and j. Using such an extended loss function improves the generalization performance of the models (see He, Xiao, et al.) because the models indirectly make use of each others' training data.

While directly optimizing Equation (1) requires access to all training data, embodiments of the present invention provide a decentralized approach. According to this approach, each participant has its own metadataM about its task i, and the similarity graph is defined in terms of this metadata (see below for examples). Advantageously, the Algorithm A below can be used by any participant at any time asynchronously, that is, without any requirements on the order or frequency of execution.

Algorithm (e.g., process) A [Participant owning its task i]
1. Publish metadataM for task i
2. Obtain, among all other participants, the set J of similar tasks based on their metadata, where J represents all of the tasks from the other participants
3. Obtain from all other participants owning its task j in the set of tasks J, the parameter vectors θⱼ; where j represents a task for another participant (e.g., a task j from the set J) and θⱼ represents the parameter vectors for each of the tasks j
4. Train the parameter vector 9 to minimize L(Xᵢ, Yᵢ, θᵢ)+Σ_{j∉J}d(θᵢ, θⱼ), where θᵢ represents the parameter vector for task i 5. Publish the parameter vector Γᵢ

In some instances, the metadata Mᵢ may be any data related to the participant's task. The metadata may be used to determine the set of similar tasks. For example, when the single-task parameters are used as the task metadata, then those parameters may be calculated by minimizing L(Xᵢ, Yᵢ, θᵢ) using its own training dataXᵢ, Yᵢ. In some variations, one or more calculations may be used to determine the metadata Mᵢ. In other variations, no calculations may be necessary. For example, if a task is related to cities such as city transportation, the Algorithm A may use the city GPS coordinates as metadata and might not need to use any calculations for the metadata. In other words, the metadata may be GPS coordinates associated with a city. In some examples, the metadata may be and/or include a size of the city of the task/participant, climate data, and/or product category and sales data.

In some examples, step 1 of the process can be skipped if the metadata has not changed since the last update. In some instances, at step 2 of the process, the set of similar tasks may be empty (e.g., at the beginning of the process, the set of similar tasks may be empty). In that case, the training in step 4 results in a single-task model, which is then published in step 5. Publishing may be done in any way which ensures that the other participants are able to perform step 2 and 3.

In some instances, in embodiments with a central registry, the registry may determine or calculate the set of similar tasks. Additionally, and/or alternatively, the participant may obtain the metadata of one or more, including all, of the other tasks and may use this to calculate the similar tasks by itself.

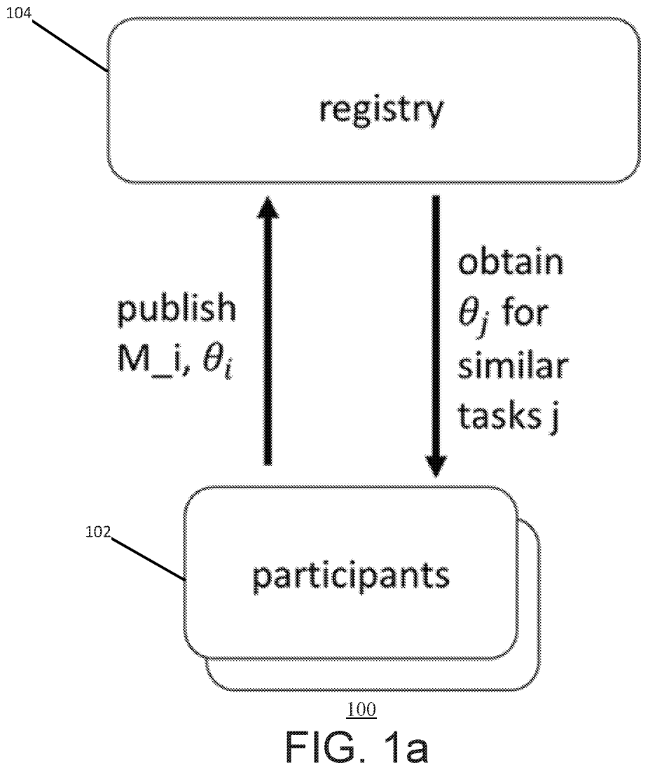

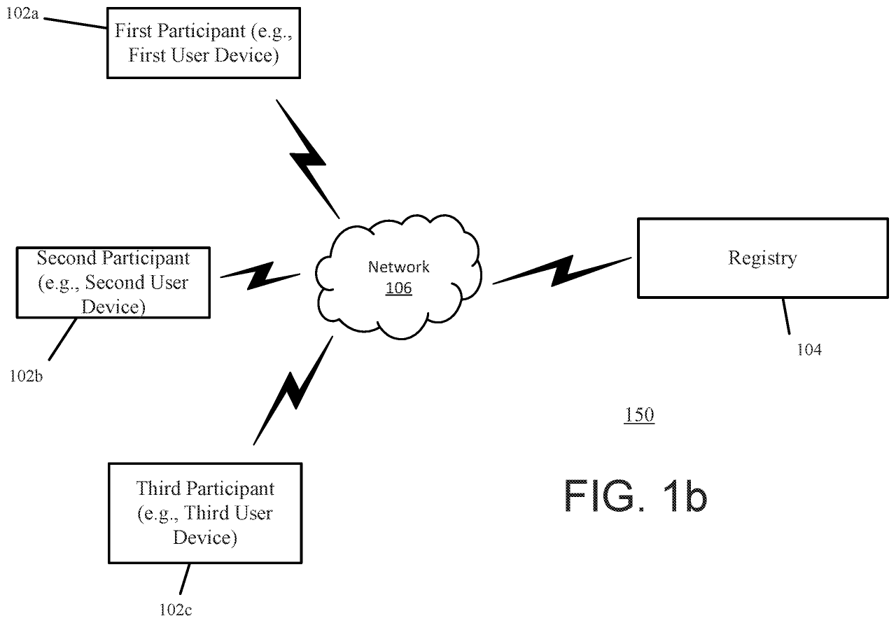

An embodiment of the present invention uses a registry for the participants such as shown in FIGS. la and lb. Referring to FIG. 1a, a communication pattern 100 includes communications between a plurality of participants 102 and a registry 104. The participants 102 may include one or more computer entities comprising one or more processors and/or memory. The registry 104 may further include one or more computer entities comprising one or more processors memory. In some instances, the registry 104 may store the metadata and/or parameters from the participants 102. For instance, the participants 102 may publish (e.g., provide, transmit, and so on) information such as the metadata Mᵢ and the parameter vector θᵢ. The registry 104 may receive and/or store the metadata Mᵢ and the parameter vector θᵢ. When requested by a participant 102, the registry 104 may provide the parameter vectors θⱼ for similar set of tasks J. The participants 102 may obtain the parameter vectors θⱼ for similar tasks J.

FIG. 1b shows an example of a method and system architecture 150 for the communication pattern 100 shown in FIG. 1a. For instance, FIG. 1b shows the registry 104 and three different participants 102a, 102b, and 103c. The system architecture 100 further includes a network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the system architecture 100. The participants 102a, 102b, and 102c may provide and obtain information from the registry 104 using the network 106. While only three participants are shown in FIG. 1b, in other variations and embodiments, the system architecture 100 may include fewer and/or additional participants.

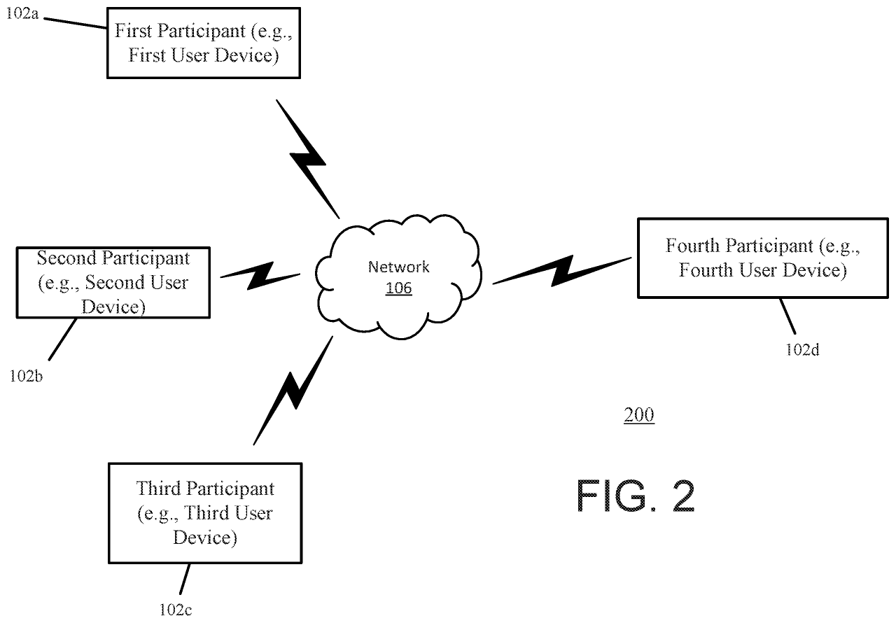

Another embodiment of the present invention may use peer-to-peer systems to achieve a completely decentralized solution such as shown in FIG. 2. FIG. 2 shows another method and system architecture 200 that includes four different participants 102a, 102b, 102c, and 102d. These four participants may communicate and provide information directly to one another without the use of a registry (e.g., the registry 104 shown in FIGS. 1a and 1b). In particular, the four participants 102a, 102b, 102c, and 102d may use the network 106 to provide and obtain the metadata M, the parameter vector θᵢ, and the parameter vectors θⱼ.

Embodiments of the present invention provide for achieving the following advantages/improvements alone or combination with each other:
1) Preserves privacy and enhances security of the participant computer systems. For instance, in some examples, participants might not reveal their training data. Also, metadata and parameters may be published in anonymized form. Moreover, for stronger security, the communication with the registry can be encrypted, and the registry may perform the similarity graph computation so that each participant only gets parameters from a number of anonymous other participants. For example, similar tasks may be defined as tasks with similar metadata. Based on the similarity definition and the task metadata, the similarity graph may be computed. For instance, one example may be to define the ten most similar tasks as neighbors in the similarity graph.
2) Provides for asynchronous use. Participants may run algorithm A at any time, independent of other participants.
3) Provides for Pareto-optimality. Participants are incentivized to run algorithm A because it improves the generalization capacity of their model with each run.
4) Provides for global optimality. Under assumption of convexity of the loss function and the distance metric, the overall solution converges against the globally optimal value of Equation (1). For instance, with an optimal value of Equation (1), all models may be expected to obtain a good performance.
5) Provides for stability and robustness. The approach works even if a subset of participants runs algorithm A rarely or never. Also, when the similarity graph changes because of metadata updates or because of participants joining or leaving, the solution may re-converge against the optimal value of Equation (1) as the participants continue to run algorithm A. The scheme is robust against the situation where the similarity graph or some parameter vector change while some participant is running algorithm A. The scheme is also robust against participants having different notions of similarity. In some instances, the similarity graph may change based on the task metadata changing. For instance, new training data for a particular task may be obtained, which may result in a change of the task metadata.
6) Increases computational efficiency and scalability. Running algorithm A has very little computational overhead as compared to training a single-task model. Also, participants can decide of the frequency of running algorithm A based on the computational resources they have available.
7) Provides a low entry barrier. New participants can join even if they have no data collected yet for training their models. In that case, Algorithm A will automatically collect existing models based on metadata similarity and compute model parameters that are close to those existing models. This is technically equivalent to initializing model parameters with pre-trained models from other tasks, which is a well-known and successful technique in machine learning.
8) Providing an extension of Algorithm A to the continual learning setting. The above Algorithm A can be extended to continual learning setting, where the objective is to efficiently learn new tasks using past knowledge without forgetting on new tasks. For any new task i, the approach first obtains the set J of similar tasks based on metadata (step 3 of Algorithm A) and then learns the task specific model following step 4 of Algorithm A. The extension to continual learning has following improvements/advantages:
   a. Provides for scalability. An added advantage is provided of adding new tasks continuously without training all the tasks together. Moreover, in a case where there are few data samples for the new task, the previously learned knowledge can help to learn efficiently a model for new task.
   b. Provides for forwards and backwards knowledge transfer. Forwards transfer of knowledge from previous tasks is attained by taking existing models into account in step 4 of Algorithm A. Backwards transfer of knowledge takes place as participants who maintain previous tasks update their task's neighborhood with the new task and re-run the algorithm.

Embodiments of the present invention are discussed in greater detail in the following.

Embodiments of the present invention include one, some or all of the following features:
1) Use of the loss function L which is minimized by participants over all values of the parameter vector θ. Any loss function from any machine learning prediction model (e.g., linear regression, neural networks, etc.) can be utilized here. For example, the loss function may be the Mean Squared Error and/or the Cross Entropy Loss. Convexity of the loss function L in the parameter vector is used to guarantee convergence to the global minimum of Equation (1), but also for non-convex loss functions, good results can be expected and convergence to a local minimum is always guaranteed.
2) The published metadata, based on which the similarity graph is defined:
   a. The parameters of single task models are a type of metadata which can always be applied (see He, Xiao, et al.). This single-task model can be different from the model trained in step 4 of Algorithm A (e.g., it can be more simple).
   b. Other parameters can describe properties of the participant (e.g., the geo-coordinates of cities where the task data has been recorded, or statistical information about the data subjects).
   c. The metadata can also change in reaction to having re-trained the model, such that the task similarity is adapted in reaction to the other participants' models.
3) The function which defines the similarity graph from the metadata:
   a. One approach is to define the neighborhood of any task as the k (e.g., k=5) most similar tasks, using, e.g., the Euclidean norm. For instance, the metadata of each task may be interpreted as coordinates, so each task may become a point in a coordinate system and the five closest other tasks are defined as the neighborhood.
   b. Another approach is to define the neighborhood of any task as all other tasks having metadata within a given Euclidean (or other) distance of h. This may be similar to a., but the neighborhood of the tasks may include all other tasks that are within a certain distance (e.g., within at most ten units of distance).
   c. When the number of training samples is published as part of the metadata, the neighborhood can be defined as the k closest tasks, where k is chosen as the smallest number such that the total number of training samples in the neighborhood exceeds a threshold N. This may be similar to a., but the neighborhood of a task may be the k closest tasks in the coordinate system, where k is chosen as the smallest number such that the total number of training samples of all neighborhood tasks is at least a specific threshold N (e.g., at least 500).
4) The distance function d used to measure the similarity between pairs of parameter vectors. In other words, the distance function may be used to measure the distance between the parameter vectors. Any norm can be utilized here.
5) The minimization method used in step 4 of Algorithm A.
   a. Gradient descent and its variants are widely used in machine learning and can be advantageously utilized here.
   b. Other optimization specialized for specific loss functions and distance functions can be utilized as well for higher efficiency (e.g., the approach of He, Xiao, et al. for linear regression with mean squared error loss and Euclidean distance).

Embodiments of the present invention are advantageously able to guarantee convergence. Convergence of the approach to a local minimum of Equation (1) can be guaranteed under the following conditions:
1) Each participant regularly executes Algorithm A over time.
2) The set of task data and the task metadata is either fixed, or becomes fixed after some time.

Furthermore, the process converges to a global minimum of Equation (1) if both the loss function and the distance function are convex.

Proof Sketch: Without loss of generality, it is assumed that the task data and metadata have become fixed already and thus the similarity graph can be considered as fixed as well. Whenever a participant that owns task i executes Algorithm A, it modifies θᵢ to minimize the value of:

L(Xᵢ, Yᵢ, θᵢ)+Σ_{j:(i,j)∉E}d(θᵢ, θⱼ) Equation (2)

which contains a subset of the summands of Equation (1), and thus the value of Equation (1) is decreased by the same margin as Equation (2). As the value of Equation (1) is lower bounded, the distributed process must converge against a set of weight vectors (θᵢ*)_{i=1 . . . N} such that no participant can improve Equation (2) anymore in Algorithm A. This means that the gradient of Equation (2) with respect to θᵢ is zero for all i=1, . . . N. As the gradient of Equation (2) with respect to θᵢ is equal to the gradient of Equation (1) with respect to θᵢ, it follows that the gradient of Equation (1) with respect to the weights of all model weights is zero. Thus (θᵢ* )_{i=1 . . . N} represents a local optimum of Equation (1). If additionally both the loss and the distance are convex, Equation (1), being a sum of convex functions, is convex as well, and then the local optimum of (θᵢ*)_{i=1 . . . N} represents a global optimum.

Embodiments of the present invention can be advantageously applied to achieve improvements in a number of technological applications such as:
1) Automated prediction systems such as smart city applications or automated transportation applications: For public services and public safety, departments of cities or regions of a country, or across several countries, publish their models and metadata for predicting socio-economic (e.g., growth, employment, tax income, utility prices, crime rates), environmental (e.g., air quality, biodiversity), and infrastructure (e.g., traffic) factors.
2) Distributed edge processing: When performing machine learning in distributed edge processing, embodiments of the present invention provide for the ability to improve the quality of the individual machine learning models on the edge devices, while only little data needs to be shared across the edge devices, as well as the ability to be robust against some devices being unavailable from time to time.
3) Computer-based healthcare systems: Due to privacy concerns, hospitals cannot share training data but still might benefit from knowledge transfer, which can be achieved using embodiments of the present invention by sharing only metadata and model weights, potentially in anonymized form. Prediction tasks here include, but are not limited to, segmentation of normal structures and segmentation of white matter lesions in brain magnetic resonance imaging (MRI) and treating electronic health record (EHR) systems as different tasks.
4) Industry 4.0: For example, for IoT applications or for prediction of maintenance requirements (tasks can, e.g., relate to different sensors, ports, wind turbines, etc.).
5) Cognitive Radio: For example, tasks can relate to predicting free wireless radio channels. For every region, there is such a task, so there would be improvements from multi-task learning according to embodiments of the present invention.

Embodiments of the present invention provide for one or more of the following improvements/advantages:
1) Provides a decentralized and asynchronous process for distributed multi-task machine learning as explained in Algorithm A and FIGS. 1a, 1b, and 2, including:
   a. publishing task metadata and the parameters of the latest model, and
   b. optimizing with regularization which only takes into account the direct neighbors in the similarity graph.
2) Provides a low adoption barrier due to simplicity of communication.
3) Avoids need to publish individual data samples.
4) Provides scalability to a massive number of tasks.
5) Provides robustness to the approach.

According to an embodiment of the present invention, a method for distributed multi-task machine learning comprises the steps of:
1) First Participant (having some training data for its task) executes Algorithm A, which includes publishing task metadata and model parameters.
2) One or more further participants (which do not necessarily need to have training data) execute Algorithm A, which includes checking whether the First Participant's task is similar to their task, and, if yes, taking into account the model parameters of the First Participant in the training of the model for their task (in the way specified in step 4 of Algorithm).

For the reasons discussed herein, the method already provides for improvements and advantages even when step 2) only includes a single further participant.

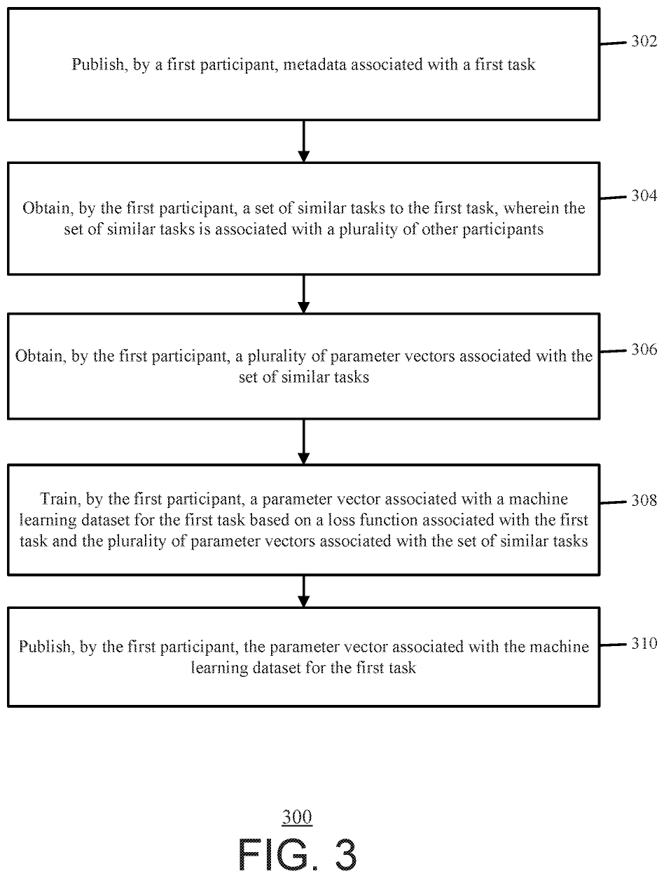

FIG. 3 is an exemplary process 300 for decentralized multi-task learning in accordance with one or more embodiments of the present application. The descriptions, illustrations, and processes of FIG. 3 are merely exemplary and the process 300 may use other descriptions, illustrations, and processes for decentralized multi-task learning. For example, the below will refer to the embodiments shown in FIGS. 1a and 1b (e.g., using the registry 104). However, as described above, the process 300 may further be used in other embodiments such as the embodiment shown in FIG. 2. The process 300 may be performed by one or more computing devices/user devices. The computing devices may include one or more processors and memory. The memory may store instructions that when executed by the one or more processors, are configured to perform the process 300.

In operation, at block 302, the first participant (e.g., participant 102a) may publish metadata associated with a first task (e.g., Tᵢ is associated with a data set Xᵢ, Yᵢ of labeled training data). The metadata may include, but is not limited to, parameters of single task models, and/or properties/characteristics of the participant. The first participant may publish the metadata and provide it to the registry 104. The task metadata may be descriptive data about the task such as, but not limited to, GPS coordinates associated with a city, size of the city, climate data, and/or product category and sales data.

At block 304, the first participant may obtain a set of similar tasks to the first task. The set of similar tasks may be associated with a plurality of other participants (e.g., participants 102b and 102c). For example, the first participant may provide a request to the registry 104 and/or directly to the other participants (e.g., the embodiment shown in FIG. 2). The first participant may obtain the set of similar tasks based on the request. In some instances, the set of similar tasks may be based on the metadata from the other participants (e.g., participants 102b and 102c). The request may include a request for the registry 104 to provide the set of similar tasks. Additionally, and/or alternatively, the request may include a request for the metadata of the other participants. The first participant may be able to use the metadata of the other participants to determine the set of similar tasks to the first task.

At block 306, the first participant may obtain a plurality of parameter vectors associated with the set of similar tasks. For example, after obtaining the set of similar tasks, the first participant may further obtain the parameter vectors for the set of similar tasks.

At block 308, the first participant may train a parameter vector associated with a machine learning dataset for the first task based on a loss function associated with the first task and the plurality of parameter vectors associated with the set of similar tasks. In some examples, the first participant may train the parameter vector associated with the machine learning dataset as described above in step 4 of Algorithm A (e.g., train the parameter vector θ_{L} to minimize L(Xᵢ, Yᵢ, θᵢ)+Σ_{j∉J}d(θᵢ, θᵢ). As described above, L(Xᵢ, Yᵢ, θᵢ) is a loss function and L expresses the prediction error. d(θᵢ,θᵢ) is a distance metric and θⱼ are the plurality of parameter vectors associated with the set of similar tasks. This distance metric may be used to measure the similarity between pairs of parameter vectors. 9 is the parameter vector associated with the machine learning dataset, which is the parameter vector that the first participant is set to minimize.

In some instances, the loss function is a convex function that may be minimized (e.g., global minimum) over time by a plurality of participants. In other instances, the loss function is a non-convex function.

At block 310, the first participant may publish the parameter vector associated with the machine learning dataset for the first task. For example, after performing block 308, the first participant may minimize the parameter vector θᵢ. Then, the first participant may publish (e.g., provide and/or transmit) this parameter vector to the registry 104.

In some examples, after the first participant (e.g., participant 102a) publishes the metadata and the parameter vector for the first task, one or more further participants (e.g., participant 102b) may execute process 300 (e.g., Algorithm A). This execution may include checking whether the first participant's task is similar to their own task and if yes, taking into account the model parameters of the first participant in the training of the model for their task.

In other words, the process 300 may be performed by any other participants within the system architecture 100 and may be performed by these participants at any time. For example, a second participant (e.g., participant 102b) may execute process 300 after the first participant publishes the metadata associated with the first task and the parameter vector associated with the machine learning dataset. The second participant, at block 302, may publish metadata associated with a second task. Then, at blocks 304 and 306, the second participant may obtain a set of similar tasks to the first task. For instance, the second participant may check to see whether the first participant's task (e.g., first task) is similar to its own task (e.g., second task). If so, the second participant may obtain the set of similar tasks to the second task, which may include the first task, as well as parameter vectors for the set of similar tasks, which may include the parameter vector associated with the first task.

At block 308, the second participant may train a parameter vector associated with a machine learning dataset for the second task based on a loss function for the second task and a plurality of parameter vector associated with the set of similar tasks, which may include the parameter vector for the first task. After, the second participant may publish the parameter vector for the second task. Then, the process 300 may repeat and the first participant, the second participant, or another participant (e.g., the third participant 102c) may perform process 300 for its own tasks.

In some instances, the participants may update their parameter vectors asynchronously. For instance, the participants may update their parameter vectors using the process 300 at different times and asynchronously with each other.

In each of the embodiments described, the embodiments may include one or more computer entities (e.g., systems, user interfaces, computing apparatus, devices, servers, special-purpose computers, smartphones, tablets or computers configured to perform functions specified herein) comprising one or more processors and memory. The processors can include one or more distinct processors, each having one or more cores, and access to memory. Each of the distinct processors can have the same or different structure. The processors can include one or more central processing units (CPUs), one or more graphics processing units (GPUs), circuitry (e.g., application specific integrated circuits (ASICs)), digital signal processors (DSPs), and the like. The processors can be mounted to a common substrate or to multiple different substrates. Processors are configured to perform a certain function, method, or operation (e.g., are configured to provide for performance of a function, method, or operation) at least when one of the one or more of the distinct processors is capable of performing operations embodying the function, method, or operation. Processors can perform operations embodying the function, method, or operation by, for example, executing code (e.g., interpreting scripts) stored on memory and/or trafficking data through one or more ASICs. Processors can be configured to perform, automatically, any and all functions, methods, and operations disclosed herein. Therefore, processors can be configured to implement any of (e.g., all) the protocols, devices, mechanisms, systems, and methods described herein. For example, when the present disclosure states that a method or device performs operation or task “X” (or that task “X” is performed), such a statement should be understood to disclose that processor is configured to perform task “X”.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the present invention. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for decentralized multi-task learning, comprising:
publishing metadata associated with a first task;
obtaining a plurality of parameter vectors associated with a set of similar tasks to the first task, wherein the set of similar tasks is associated with a plurality of other participants;
training a parameter vector associated with a machine learning dataset for the first task based on a loss function associated with the first task and the plurality of parameter vectors associated with the set of similar tasks; and
publishing the parameter vector associated with the machine learning dataset for the first task.

2. The method according to claim 1, further comprising:
obtaining the set of similar tasks to the first task, wherein the set of similar tasks are performed by the plurality of other participants.

3. The method according to claim 1, wherein the metadata comprises a plurality of parameters associated with a single task model and one or more other parameters associated with properties of the first participant.

4. The method according to claim 1, wherein publishing the metadata comprises providing the metadata associated with the first task to a registry,
wherein obtaining the plurality of parameter vectors comprises obtaining, from the registry, the plurality of parameter vectors based on providing the metadata to the registry, and
wherein publishing the parameter vector comprises providing the parameter vector to the registry.

5. The method according to claim 1, wherein the method is performed by a first participant device, and wherein the plurality of other participants comprises a second participant device,
wherein the plurality of parameter vectors comprises a set of parameter vectors associated with the second participant.

6. The method according to claim 5, wherein publishing the metadata comprises providing the metadata associated with the first task to the second participant device,
wherein obtaining the plurality of parameter vectors comprises obtaining, from the second participant device, the plurality of parameter vectors based on providing the metadata to the second participant device, and
wherein publishing the parameter vector comprises providing the parameter vector to the second participant device.

7. The method according to claim 1, wherein training the parameter vector associated with the machine learning dataset is based on minimizing the parameter vector using a first function comprising the loss function and a distance metric associated with the plurality of parameter vectors.

8. The method according to claim 7, wherein the distance metric is a norm function that determines similarities between the parameter vector and the plurality of parameter vectors associated with the set of similar tasks.

9. The method according to claim 1, wherein the plurality of other participants comprises a second participant associated with a second participant device,
wherein the second participant device uses the parameter vector associated with the first task to train a second parameter vector associated with a second machine learning dataset for a second task, and
wherein the second participant device publishes second metadata associated with the second task and the second parameter vector.

10. A system for decentralized multi-task learning, the system comprising:
a first participant device comprising one or more first processors which, alone or in combination, are configured to facilitate:
publishing metadata associated with a first task;
obtaining a plurality of parameter vectors associated with a set of similar tasks to the first task, wherein the set of similar tasks is associated with a plurality of other participants;
training a parameter vector associated with a machine learning dataset for the first task based on a loss function associated with the first task and the plurality of parameter vectors associated with the set of similar tasks; and
publishing the parameter vector associated with the machine learning dataset for the first task.

11. The system according to claim 10, wherein the one or more first processors are configured to further facilitate:
obtaining the set of similar tasks to the first task, wherein the set of similar tasks are performed by the plurality of other participants.

12. The system according to claim 10, further comprising:
a registry comprising one or more second processors which, alone or in combination, are configured to facilitate:
receiving, from the first participant device, the metadata associated with the first task;
providing, to the first participant device, the plurality of parameter vectors associated with the set of similar tasks to the first task; and
receiving, from the first participant device, the parameter vector associated with the machine learning dataset for the first task.

13. The system according to claim 10, wherein the system further comprises:
a second participant device comprising one or more second processors which, alone or in combination, are configured to facilitate:
publishing second metadata associated with a second task;
obtaining a plurality of second parameter vectors associated with a set of second similar tasks to the second task, wherein the plurality of second parameter vectors comprises the parameter vector associated with the first task, and wherein the set of second similar tasks comprises the first task;
training a second parameter vector associated with a second machine learning dataset for the second task based on a second loss function associated with the second task and the plurality of second parameter vectors; and
publishing the second parameter vector associated with the second machine learning dataset for the second task.

14. The system according to claim 13, wherein the one or more first processors, alone or in combination, are configured to further facilitate:
updating the parameter vector associated with the machine learning dataset at a first time, and
wherein the one or more second processors, alone or in combination, are configured to further facilitate:
updating the second parameter vector associated with the second machine learning dataset at a second time that is different from and asynchronous with the first time.

15. A tangible, non-transitory computer-readable medium having instructions thereon which, upon being executed by one or more processors, alone or in combination, provide for execution of a method comprising:
publishing metadata associated with a first task;
obtaining a plurality of parameter vectors associated with a set of similar tasks to the first task, wherein the set of similar tasks is associated with a plurality of other participants;
training a parameter vector associated with a machine learning dataset for the first task based on a loss function associated with the first task and the plurality of parameter vectors associated with the set of similar tasks; and
publishing the parameter vector associated with the machine learning dataset for the first task.
